(19) United States
(12) Patent Application Publication
(10) Pub. No.: US 2006/0072793 A1
(43) Pub. Date: Apr. 6, 2006

(54) Security alarm notification using iris detection systems

(75) Inventor: Gary E. Determan, Maple Grove, MN (US)

Correspondence Address: Kris T. Fredrick;Honeywell International, Inc., 101 Columbia Rd., P.O. Box 2245, Morristown, NJ, 07962, US

(73) Assignee: Honeywell International, Inc.

(21) Appl. No.: 10/958,928

(22) Filed: Oct. 5, 2004

(51) Int. Cl. G06K 9/00

(52) U.S. Cl. 382/117

(57) ABSTRACT

Biometric iris detection systems are adaptable for control of alarm conditions through the systems scanner or reader by physical actions of a user's eye and/or eye lid. An alarm condition can be set in a biometric iris detection system following a predetermined blinking pattern by a user's eyelid. An alarm condition also can be set in a biometric iris detection system following closure of a user's eyelid for a predetermined time following user identification/acceptance by the system. An alarm condition can following a predetermined movement patter of a user's eyeball (e.g., a user looks at a particular area, or areas, within a biometric reader, e.g., upper left, upper right, lower left, lower right, during user identification and acceptance procedures. The embodiments of the present invention can be carried out using biometric iris detection hardware and image processing/control software.

### TECHNICAL FIELD

The present invention is generally related to biometric systems. The present invention is also directed to methods of and systems related to biometric iris detection. More particularly, the present invention is related to methods enabling user manipulation of a biometric iris detection system through an iris scanner or reader.

### BACKGROUND OF THE INVENTION

Providing adequate security for electronic and mechanical systems has rapidly become an important issue in recent years. With the proliferation of computers, computer networks and other electronic device and networks into all aspects of business and daily life, the concern over secure file and transaction access has grown tremendously. The ability to secure data and transactions is particularly important for financial, medical, education, government, military, and communications endeavors.

Using passwords is a common method of providing security for electrical or mechanical systems. Password protection and/or combination type locks are employed for computer network security, automatic teller machines, telephone banking, calling cards, telephone answering services, buildings, factories, houses and safes. These systems generally require the knowledge of an entry code that has been selected by or provided to a user or has been configured in advance.

Pre-set codes are often forgotten, however, as users have no reliable method of remembering them. Writing down codes and storing them in close proximity to an access control device (e.g., a combination lock) results in an insecure access control system. Alternatively, the nuisance of trying several code variations generally renders the access control system more of a problem than a solution.

Password systems are known to suffer from other disadvantages. Usually, a user specifies passwords. Most users, being unsophisticated users of security systems, choose passwords that are relatively insecure. As such, many password systems are easily accessed through a simple trial and error process.

To secure access to particular areas, such as buildings, the most common building security system relied on traditionally has been a security guard. A security guard reviews identification cards and compares pictures thereon to a person carrying the card. The security guard provides access upon recognition or upon other criteria. Other building security systems use card access, password access, or another secure access approach. Unfortunately, passwords and cards have similar drawbacks when utilized for building security, particularly with computer security.

As an alternative to traditional security approaches, such as security guards, passwords or PIN numbers, biometric authentication systems have been developed to authorize accesses to various electronic and mechanical systems. Biometrics can generally be defined as the science of utilizing unique physical or behavioral personal characteristics to verify the identity of an individual. Biometric authentication systems are typically combined with hardware and software systems for automated biometric verification or identification. Biometric authentication systems receive a biometric input, such as a fingerprint or a voice sample, from a user. This biometric input is typically compared against a prerecorded template containing biometric data associated with the user to determine whether to grant the user access to a service on the host system.

A biometric security access system can thus provide substantially secure access and does not require a password or access code. A biometric identification system accepts unique biometric information from a user and identifies the user by matching the information against information belonging to registered users of the system. One such biometric system is an iris recognition system.

In an iris biometric system, a user's iris under investigation is usually scanned by an optical scanner integrated with an ergonomic housing designed to orient a user's face and, more particularly, eye area in front of the scanner. In order to capture an image of a fingerprint, a system will require that the user remain in place for a few moments while an image of the iris is captured by the scanner. The iris pattern is recorded and compared to biometric templates store in a database to determine whether there is a match with a user having access to the building, system or data being protected by the biometric system.

In evaluating security of biometric authorization systems, false acceptance and false rejections are sometimes evaluated as a fraction of a user population. A security system may be characterized as allowing 1 in 1,000 false acceptances or, alternatively, 1 in 1,000,000. Typically a probability distribution curve establishes a cut off for a given registration to determine what false acceptance rate this reflects. Curves of this type are exponential in nature and, therefore, for better false acceptance rates provide only nominal improvements to false acceptance rate for significant changes to a threshold value. Typically when using a biometric information sample, a low match score results in failure to authorize an individual.

A potential problem with biometrics is the potential that a foe may force an authorized user of biometric-protected systems, buildings and data to gain access to the protected systems, buildings or data. Once the user has been authenticated, the foe will have access to the protected system. A breach in security cannot be overcome without further warning once the breach has happened.

The present inventor believes it is important to have a method to set/control alarm conditions through biometric iris detection systems.

### SUMMARY OF THE INVENTION

It is a feature of the present invention to enable a user to set alarm conditions using a biometric system through an iris scanner or reader.

It is another feature of the present invention to provide methods of manipulating biometric iris detection system by a user's eyeball/eyelid to cause setting of an alarm condition by the system.

It is yet another feature of the present invention that alarm conditions can be set in a biometric iris detection system following a predetermined blinking pattern by a user's eyelid.

It is yet another feature of the present invention that alarm conditions also can be set in a biometric iris detection system following closure of a user's eyelid for a predetermined time following user identification/acceptance by the system.

It is yet another feature of the present invention that alarm conditions can be set following a predetermined movement patter of a user's eyeball (e.g., a user looks at a particular area, or areas, within a biometric reader, e.g., upper left, upper right, lower left, lower right, during user identification and acceptance procedures.

It is another feature of the present invention that methods setting alarm conditions using a user's eyeball/eyelid can be carried out using biometric iris detection hardware and image processing/control software.

A first embodiment of the invention provides that an alarm condition can be set in a biometric iris detection system by looking into the system and blinking the eye for a number of times.

### BRIEF DESCRIPTION OF THE DRAWINGS

The novel features believed characteristic of this invention are set forth in the appended claims. The invention itself, however, as well as a preferred mode of use, further objects, and advantages thereof, will best be understood by reference to the following detailed description of an illustrative embodiment when read in conjunction with the accompanying drawings, wherein:

FIG. 1 depicts a prior art block diagram illustrating components of an electronic system associated with a database containing biometric attributes in which preferred embodiments of the present invention can be implemented;

FIG. 2 illustrates a prior art block diagram of client computer systems coupled to host systems through a network in which preferred embodiments of the present invention can be implemented;

FIG. 3 illustrates a prior art block diagram of some of the functional components within the client computer system depicted in FIG. 2, which can be utilized to implement an embodiment of the present invention;

FIG. 4 depicts a prior art block diagram illustrating biometric iris detection system, which may be adapted and utilized in accordance with carrying out preferred embodiments of the present invention;

FIG. 5 illustrates a flow chart of prior art operations for authenticating a user in accordance with an embodiment of the present invention;

FIG. 6 illustrates a block diagram o a biometric iris detection and authentication system used for authenticating a user and enabling user-initiated alarm conditions in accordance with embodiments of the present invention; and

FIG. 7 depicts a flow diagram of a method of carrying out embodiments of the present invention using a biometric iris detection system.

### DETAILED DESCRIPTION OF EMBODIMENTS OF THE INVENTION

Thus, the present invention is not intended to be limited to the embodiments shown or described below, but is to be accorded the widest scope consistent with principles and features disclosed herein. Although preferred embodiments of the present invention are described herein, those skilled in the art can appreciate that a number of varying embodiments can be implemented in accordance with the present invention.

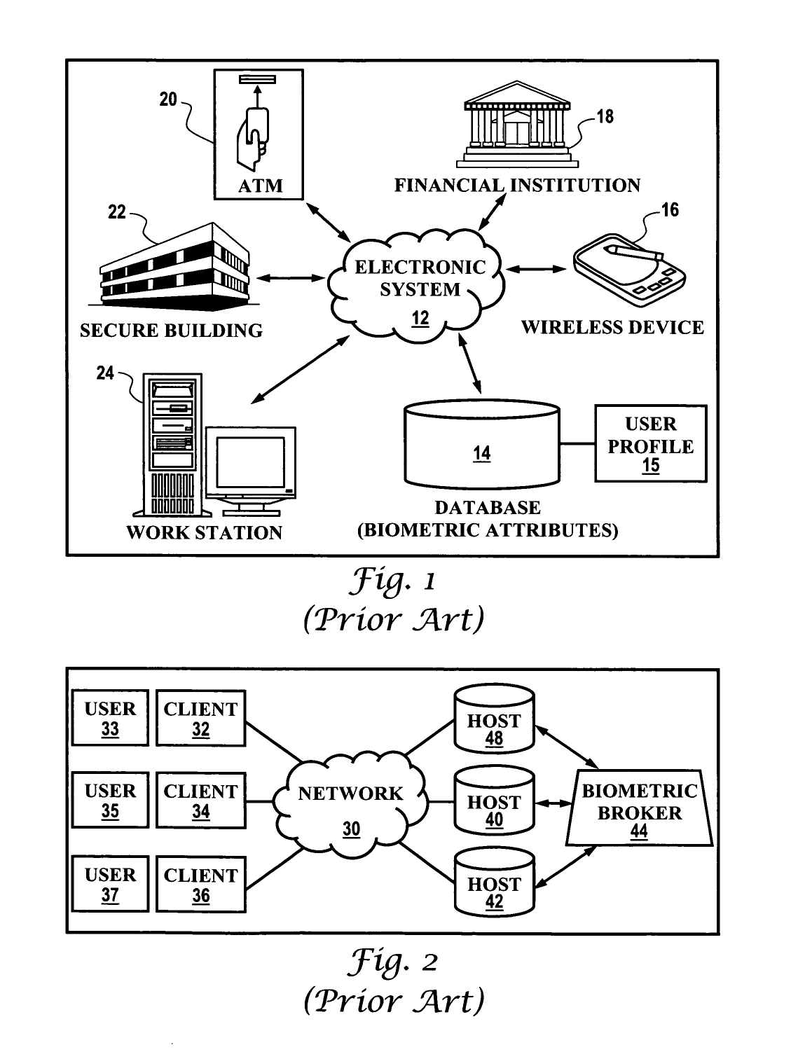

FIG. 1 illustrates a block diagram of components of an electronic system 12 associated with a database or memory containing biometric attributes 14, in which preferred embodiments of the present invention can be implemented. Database 14 can be linked or integrated with electronic system 12 and can include a at least one user profile 15 containing biometric templates (i.e., samples) of biometric attributes provided previously by particular users. Electronic system 12 can interact with and communicate with a variety of devices and mechanical systems.

Electronic system 12 can, for example, communicate with a computer workstation 24. In such an example, electronic system 12 can be configured as a remote computer network (e.g., the Internet), or a dedicated computer network (e.g., Intranet, WLAN, LAN, etc.) operating within a particular organization, business or institution. Electronic system 12 can also be configured to communicate with electromechanical systems, such as entry hardware of a secure building 22. A user can access electronic system 12 to secure entry to secure building 22. In some applications, electronic system 12 can be configured as electronics associated with or resident within the user interface (e.g., typical of non-networked systems, such as secure entries).

Additionally, electronic system 12 can be configured to communicate with an Automatic Teller Machine (ATM) 20 and/or point of sale. A user attempting to retrieve cash through ATM 20 can be required to authentication his or her identification, based on previously stored biometric attributes contained within database 14 and/or user profile 15. Database 14 and user profile 15 can function as a biometric broker that communicates as a third-party service with various mechanical systems and other devices through electronic system 12. Electronic system 12 can also enable communication with a financial institution 18 and wireless device 16.

In order to communicate with wireless device 16, electronic system 12 can be configured as part of a wireless network. A wireless device 16 can be, for example, a wireless telephone or a wireless hand held device that can communicate with wireless networks to send and receive data. Wireless device 16 can be, for example, a Wireless Application Protocol (WAP), 3G, CDMA and WiFi enabled communications device configured to authenticate the identity of a user through a biometric scanner integrated with or attached to the wireless device.

FIG. 2 illustrates a prior art system diagram with client computer systems 32, 34, and 36 coupled to host computer systems 48, 40, and 42 through a network 30, in which preferred embodiments of the present invention can be implemented. Network 30 can be any communication channel through which computer systems can communicate. This includes, but is not limited to, local area networks, such as Ethernet or Token ring, and wide area or remote computer networks, such as the Internet and World Wide Web, well known in the networking arts.

Network 30 can also be implemented as a wireless network through which wireless devices, such as wireless device 16 of FIG. 1, can communicate with other devices and other systems. A client, such as client systems 32, 34, and 36 can be any node on a computer network including computational capability and including a mechanism for communication across network 30. Human users 33, 35, and 37 can operate client systems 32, 34, and 36, respectively. A host, such as host systems 48, 40 and 42, can be any node on a computer network including a mechanism for servicing requests from a client for computational or data storage resources. Hosts can also be implemented as servers.

Host systems 48, 40 and 42 can be coupled to biometric broker 44. Biometric broker 44 can be implemented as a centralized repository for storing biometric attributes (i.e., biometric data), such as iris matching data. Biometric broker 44 can also be configured as an entity that obtains biometric data form a variety of biometric databases operated by different entities and organizations, and utilizes such information for authentication purposes.

Biometric brokers 44 can be implemented in any number of forms. In one possible embodiment, biometric broker 44 can be implemented as a node on network 30, which communicates with host systems 48, 40, and 42 across network 30. In another possible embodiment, biometric broker 44 can be located on a host, such as host system 48.

The example illustrated in FIG. 2 can operate generally as follows. A user, such as user 33, works on a client, such as client system 32. User 33 can request access to resources on host system 48 across network 30. In response to this request, host system 48 attempts to authenticate user 33. In doing so, host system 48 requests a biometric attribute (i.e., biometric data) from biometric broker 44. Biometric broker 44 returns a biometric attribute or biometric template, which can be compared against sample biometric attribute(s) randomly collected from user 33. This comparison can take place at a number of locations, including at client system 32, at host system 48 or at biometric broker 44. If the sample biometric attribute collected from user 33 matches the biometric attribute retrieved from biometric broker 44, user 33 can be permitted to access resources on host system 48.

Providing a centralized authentication service such as biometric broker 44 has a number of advantages. One advantage is generally that centralized revocation can be supported. For example, an employee in an organization typically has access to a number of different resources on a number of different host systems. When this employee leaves the organization, it often takes a long time to explicitly revoke the employee's access rights on all host systems. Under a centralized revocation scheme, such revocation only needs to take place once at the centralized revocation service since the disparate host systems always look to the centralized revocation service to authenticate a user. Further, the biometric broker 44 can serve as the central reporting station for recording attempted biometric entries resulting in alarm conditions.

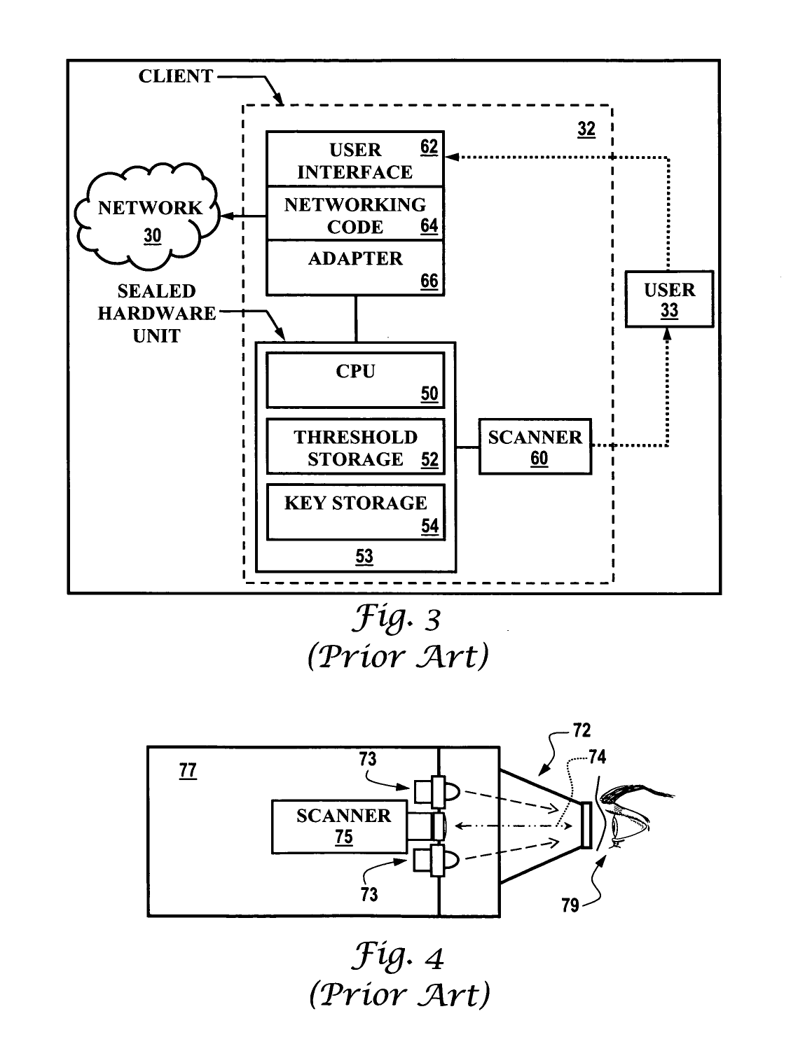

FIG. 3 illustrates a block diagram illustrating some of the functional components within a prior art client computer system 32 that can be utilized to implement an embodiment of the present invention. Note that in FIGS. 2 and 3 identical parts are represented by identical reference numerals. As mentioned above, client system 32 can be any node on a computer network including computational capability and including a mechanism for communication across network 30. In the illustrated embodiment, client system 32 includes user interface 62, networking code 64 and adapter 66. These functional components can be implemented in software running on, for example, a client CPU. User interface 62 provides a mechanism through which user 33 can operate client system 32. Networking code 64 can include a library of functions, which allow client system 32 to communicate across network 30. Adapter 66 can include a collection of functions that implement the client portion of a biometric authentication system according to one embodiment of the present invention.

Adapter 66 can communicate with sealed hardware unit 53, which can be utilized to perform biometric authentication functions. In the example illustrated in FIG. 3, sealed hardware unit 53 can be encased in a sealed insulating layer, which prevents a malicious user of client system 32 from monitoring the computational operations performed within sealed hardware unit 53. This can prevent a malicious user from improperly gaining access to host system 48, even if the malicious user has the power to modify hardware and software resources on client system 32. The circuitry inside sealed hardware unit 53 can be encased in the insulating layer in such a manner that any attempt to cut through the insulating layer to monitor the circuitry is likely to render the circuitry inoperable. Of course, such features are presented herein for illustrative purposes only and should not be interpreted as limiting features of the present invention.

Sealed hardware unit 53 can include a CPU 50, which can be any type of computational engine that can be used to perform the computational and logical operations involved in biometric authentication. Sealed hardware unit 53 can additionally include threshold storage 52 and key storage 54. Threshold storage 52 can be utilized as a memory location for storing threshold values indicating how closely a biometric attribute take as a biometric sample from a user must match a biometric attribute retrieved from a database through biometric broker 44, in order to allow the user to access the host system. Key storage 54 can store at least one encryption key that can be used to encrypt messages or computer checksums for communications across network 30.

Sealed hardware unit 53 can communicate with scanner 60, which can be utilized to take a biometric sample (i.e., iris scan) from user 33. This biometric attribute can be any type of biometric measurement of user 33. This includes, but is not limited to, fingerprint data, iris scan, retinal scan, handwriting data, voice data (e.g., a voice print), and facial data (e.g., a face scan). Note that the biometric attributes stored as data within a database, such as biometric database 14 and/or user profile 15 of FIG. 1 can be stored as a template or “biometric template”.

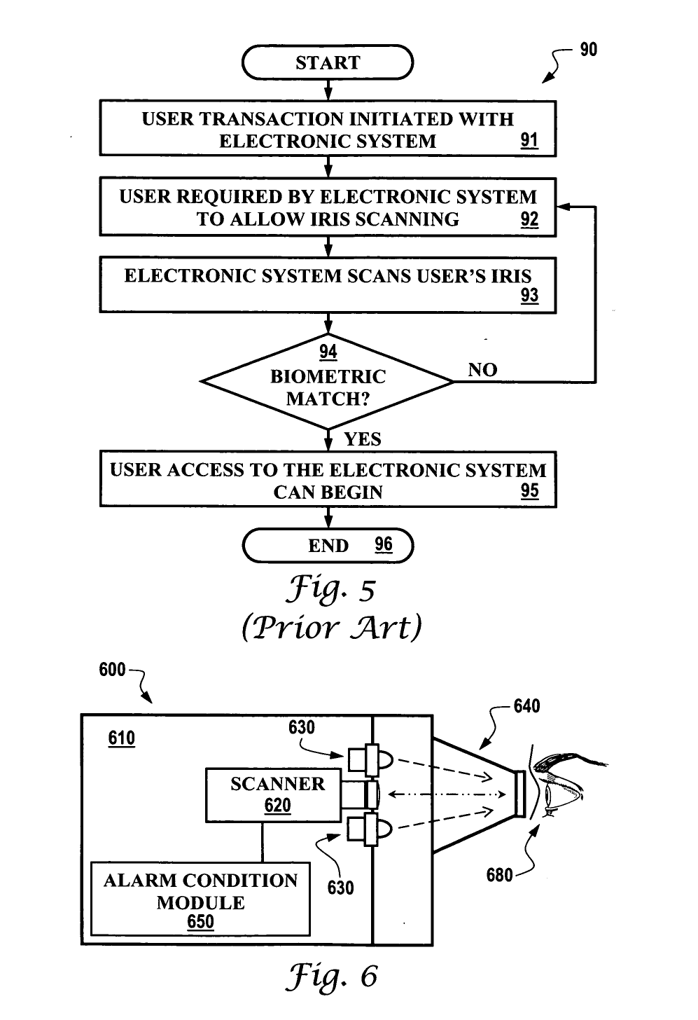

The components illustrated in FIG. 3 can operate as follows. User 33 initiates the biometric authentication process by seeking access to resources on a host system, such as host system 48 of FIG. 2, through user interface 62. This causes authentication code within adapter 66 to initiate communications with host system 48 (i.e., host system 48 illustrated in FIG. 2). This authentication code within adapter 66 can additionally initiate operations within sealed hardware unit 53 to gather a biometric attribute as a biometric sample from user 33 through scanner 60. These authentication operations are described in more detail below with reference to the flow charts in FIGS. 5 and 6.

Typical biometric measurements, which can be utilized to authenticate identity, include iris scanning and verification. Referring to FIG. 4, a block diagram of a prior art iris scanning system 70 is shown. Unique random patterns formed in the colored area of a person's eye 79 (the iris) provide a strong basis for biometric access control. The iris scanning system 70 includes a housing 77 for containing a scanner 75 and supporting a user interface 72. The user interface 72 can be provided as a padded interface upon which the user can rest the facial area around his eye 79; although it should be appreciated that physical contact with the user interface 75 is not completely necessary for the system to work. The user interface 72 not only provides a comfortable interface for the user but, more importantly, it brings the user's eye 79 into proper alignment with the imaging path 74 for the scanner 75. The system 70 will typically provide an infrared light source 73 that can generate enough background or direct light to illuminate the user's iris so that the scanner to adequately capture an image of the iris.

Iris scanning and identification is generally well known in the biometric arts and is widely used in government agencies to safeguard sensitive assets and information that is vital to national security. Iris scanning does not rely on the iris's color. Iris scanning is generally based on the fact that the color portion of the eye that surrounds the pupil contains patterns that are unique to each individual. An individual's physical signature is another important biometric attribute that can be utilized to verify the identity of an individual. Signature verification can be readily utilized with the other biometric measuring techniques utilized above.

FIG. 5 illustrates a flow chart 90 wherein prior art operations for authenticating a user, in accordance with an embodiment of the present invention, are listed. The process can be initiated as indicated at block 91 when a user transaction is initiated with an electronic system. Such an electronic system can, for example, be configured as an ATM and/or a physically secured entry linked to a computer network that communicates with a biometric broker, such as biometric broker 44 of FIG. 2. As explained previously, such a biometric broker can be composed of a database containing biometric attributes and/or a user profile integrated with or in communication with the database. The user profile contains previously store biometric attributes of a particular user. A user during enrollment can provide biometric attributes. During such an enrollment stage, samples of designated biometric attributes can be acquired. One or more unique features of the samples can then be configured to form a biometric template of one or more biometric attributes for subsequent comparison purposes.

As depicted next at block 92 of the flow diagram, the user is requested by the electronic system to allow the system to scan the user's iris. Thereafter, as illustrated at block 93, the electronic system scans the user's iris. As described next at block 94, a comparison is made between the biometric attribute (iris scan) captured by the electronic system to a biometric template wherein a matching biometric attribute should be stored. If a match does not occur, then the process can be repeated, for example, beginning with the operation depicted at block 92. Alternatively, if the match is a success, then user access to the electronic system can begin, as indicated at block 95. The user session is thereafter terminated as shown in block 96.

Assuming a match occurs, then as depicted at block 95, the user is permitted to perform a user-desired activity such as, for example, performing financial transactions, accessing sensitive information, entry into a secured building. If a biometric attribute input by the user to the electronic system matches, but the match was accomplished under force or duress by a third party, then the user and the third party will still be granted access. Unfortunately, with present biometric systems, it is possible for a user to gain access to secured systems when forced by a thief at an ATM, or opposing government forces wanting access to sensitive information or building entry.

The present invention provides methods that an authorized person can use to trigger an alarm condition when biometric initiated access is forced. In a first embodiment of the invention, an alarm condition can be set in a biometric iris detection system if the user looking into the system and blinking the eye for a number of times. A second embodiment of the invention provides that a biometric iris detection system is used to set an alarm condition when a user looks at a particular area within the biometric reader (e.g., upper left, upper right, lower left, lower right). In a third embodiment, a user sets an alarm condition by looking into the in a biometric iris detection system and closing the eye for a period of time after acceptance has occurred. The embodiments of the present invention can be carried out using biometric iris detection hardware and image processing/control software.

Referring to FIG. 6, a biometric system 600 is illustrated that includes an alarm condition module 650 that can operate simultaneously with the iris scanning procedures conducted to authenticate a user. The biometric system shown in FIG. 6 includes a housing 610, scanner 620, background lighting 630 and a user interface 640. The alarm condition module 650 can operate simultaneously with iris scanning and matching for user authentication by assessing images continually being captured by the scanner. The alarm condition module 650 assesses the user's eye 680 movements and/or eyelid movements to determine if a silent “call for help” is in progress.

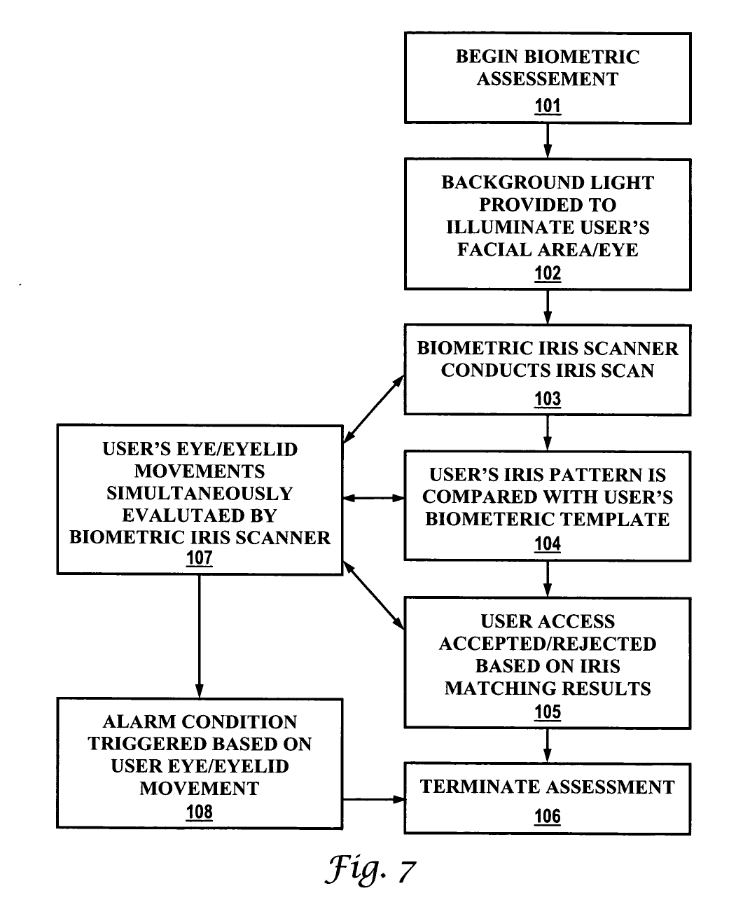

Referring to the flow diagram in FIG. 7, a flow diagram for a method of using the invention is illustrated. The user begins the biometric assessment process as shown in block 101. Biometric assessment is typically initiated by a user seeking privileges (e.g., network access, building access, e-commerce). The biometric system will begin by providing background lighting to adequately illuminate the user's eye/facial area as shown in block 102. After, or simultaneous with, the background lighting initiation, a biometric scanner captures at least one image of the user's iris as shown in block 103. Simultaneously with iris scanning during the step in block 103, the user's eye and/or eyelid can be evaluated form movement through the iris scanner as shown in block 107.

Movement as shown in block 107 can continue through the iris matching process shown in block 104, and also as the user is being accepted and permission is being granted for privileges as shown in block 105. Eye and/or eyelid movement assessment is being observed during the biometric process so that the system can determine whether a predetermined alarm condition is being signaled by the user during biometric authentication. If a predetermined alarm condition, which would be known by the user, is captured by the scanner, the biometric system can trigger an alarm as shown in block 108. Predetermined conditions that can trigger an alarm include any of the following:
biometric reader captures a predetermined blinking pattern by the user's eye lid;
closure of the user's eye lid for a predetermined length of time after the user has been identified and/or accepted; and
a predetermined movement pattern by the user's eyeball.

Even where an alarm condition is determined by the biometric system to exist following action by the user, the user can still be granted access to privileges. Such a scenario would be desired where life or limb is threatened and a silent alarm may spare the user's life. Another reason for allowing access, but triggering a false alarm, would be where it is more desirable to catch perpetrators in the act of gaining access to secured material or facilities. Once the biometric assessment and alarm condition assessments are completed the process terminates as shown in block 106.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A biometric system comprising:
an iris detector and reader; and
a microprocessor adaptable to control alarm conditions following physical actions by a user's eyeball and/or eye lid captured by the iris detector and reader and analyzed by the microprocessor.

2. The system of claim 1 further comprising an image processing software module operable within the biometric system to enable said microprocessor to order an alarm condition when the iris detector and reader captures a predetermined blinking pattern by the user's eye lid.

3. The system of claim 1 further comprising an image processing software module operable Within the biometric system to enable said microprocessor to order an alarm condition when the iris detector and reader captures closure of the user's eye lid for a predetermined length of time after the user has been identified and/or accepted.

4. The system of claim 1 further comprising an image processing software module operable within the biometric system to enable said microprocessor to order an alarm condition when the iris detector and reader captures a predetermined movement pattern by the user's eyeball.

5. A method for assessing a biometric iris detector user's eyeball and/or eyelid movements for alarm conditions, the method comprising the steps of:
a user begins the biometric iris assessment process at a biometric system;
the biometric system provides background lighting to illuminate the user's eye/facial area;
a scanner integrated with the biometric system captures at least one image of the user's iris and matches the image with templates stored in a memory that represent the user's iris;
simultaneously with iris scanning and matching, the user's eyeball and/or eyelid movements are captured by the scanner and evaluated for a predetermined alarm condition;
if a predetermined alarm condition is signaled by the user's eyeball and/or eyelid movements, the biometric system triggers an alarm.

6. The method of claim 5 wherein the user's eyeball and/or eyelid movements are evaluated for predetermined movement throughout the iris matching process and also as the user is being accepted by the biometric system and permission is being granted for privileges.

7. The method of claim 5 wherein eyeball and/or eyelid movement that causes alarm conditions are known by the user prior to the user beginning the biometric assessment.

8. The method of claim 7 wherein movement that causes alarm conditions include at least one of:
the scanner captures a predetermined blinking pattern by the user's eye lid;
the scanner captures closure of the user's eye lid for a predetermined length of time after the user has been identified and/or accepted; and
the scanner captures predetermined movement pattern by the user's eyeball.

9. The method of claim 5 wherein movement that causes alarm conditions include at least one of:
the scanner captures a predetermined blinking pattern by the user's eye lid;
the scanner captures closure of the user's eye lid for a predetermined length of time after the user has been identified and/or accepted; and
the scanner captures predetermined movement pattern by the user's eyeball.

10. The method of claim 5 wherein the user is granted access to privileges although an alarm condition is determined to exist by the biometric system.

11. The method of claim 6 wherein the user is granted access to privileges although an alarm condition is determined to exist by the biometric system.

12. The method of claim 7 wherein the user is granted access to privileges although an alarm condition is determined to exist by the biometric system.

13. The method of claim 8 wherein the user is granted access to privileges although an alarm condition is determined to exist by the biometric system.

14. The method of claim 9 wherein the user is granted access to privileges although an alarm condition is determined to exist by the biometric system.

15. The method of claim 5, wherein the process terminates once the biometric assessment and alarm condition assessments are completed.

16 A method for assessing a biometric iris detector user's eyeball and/or eyelid movements for alarm conditions, the method comprising the steps of:
(a) a user begins the biometric iris assessment process at a biometric system;
the biometric system provides background lighting to illuminate the user's eye/facial area;
(b) a scanner integrated with the biometric system captures at least one image of the user's iris and matches the image with templates stored in a memory that represent the user's iris;
(c) simultaneously with iris scanning and matching, the user's eyeball and/or eyelid movements are captured by the scanner and evaluated for a predetermined alarm condition;
(d) the biometric system triggers an alarm if a predetermined alarm condition signaled by the user's eyeball and/or eyelid movements is captured by the scanner, said predetermined alarm condition including at least one of:
(i) a predetermined blinking pattern by the user's eye lid;
(ii) the scanner captures closure of the user's eye lid for a predetermined length of time after the user has been identified and/or accepted; and
(iii) the scanner captures predetermined movement pattern by the user's eyeball.

17. The method of claim 16 wherein the user's eyeball and/or eyelid movements are evaluated for predetermined movement throughout the iris matching process and also as the user is being accepted by the biometric system and permission is being granted for privileges.

18. The method of claim 16 wherein eyeball and/or eyelid movement that causes alarm conditions are known by the user prior to the user beginning the biometric assessment.

19. The method of claim 5 wherein the user is granted access to privileges although an alarm condition is determined to exist by the biometric system.
